(19) United States
(12) Patent Application Publication
(10) Pub. No.: US 2013/0058073 A1
(43) Pub. Date: Mar. 7, 2013

(54) Illuminated Door Assembly for an Electrical Outlet Cover

(71) Applicants: Philip Walker, Calgary (CA); Nicole Atkinson, Calgary (CA)

(72) Inventors: Philip Walker, Calgary (CA); Nicole Atkinson, Calgary (CA)

(21) Appl. No.: 13/224,598

(22) Filed: Sep. 2, 2011

(51) Int. Cl. F21V 33/00

(52) U.S. Cl. 362/95

(57) ABSTRACT

An illuminated door assembly includes a panel having a front side, a rear side, and a through opening and is registered and used with an electrical receptacle of an electrical outlet. The opening, of sufficient size to permit access to the electrical receptacle, permits the plugging of an electrical cord with the electrical receptacle. A door panel is hingedly attached to the panel for rotation between a closed position and an open position. A light source is carried by the panel. The panel and door each include clear faces through which light emitted by the light source is projected outwardly. Electrical prongs, pivotally connected to the panel for rotation between retracted and extended positions, are operatively connected to the light source for providing electrical power to the light source when the electrical prongs are received by an electrical receptacle of the electrical outlet in connection with the assembly.

### FIELD OF THE INVENTION

The present invention relates generally to electrical outlet safety devices, and more particularly, relating to an illuminated door assembly for preventing access to an electric receptacle by an infant or small child.

### BACKGROUND OF THE INVENTION

Night lights and safety covers for electrical outlets exist in the art. While these devices fulfill their respective objectives and requirements, there exists a need for a new and improved illuminated door assembly for an electrical outlet.

### SUMMARY OF THE INVENTION

The embodiments of the present invention addresses this need by providing an illuminated door assembly that may be used in connection with existing safety guards devices or may be used alone which includes conceals an electrical outlet and provides limited access to an electrical receptacle of the electrical outlet, and which is illuminated to serve as a night light.

To achieve these and other advantages, in general, in one aspect, an illuminated door assembly for an electrical outlet is provided. The assembly includes a panel having a front side, a rear side and a through opening extending from the front side to the rear side thereof that is registered with an electrical receptacle of an electrical outlet with which the assembly is used in connection with. The opening is of a sufficient size to permit access to the electrical receptacle permit the plugging of an electrical cord with the electrical receptacle. A door panel is hingedly attached to the panel for rotation between a closed position wherein the through opening is covered and an open position wherein the through opening uncovered and is accessible. A light source is carried by the panel and the panel and the door each include clear faces through which light emitted by the light source is transmitted and projected outwardly. Electrical prongs are pivotally connected to the panel for rotation between retracted and extended positions. The electrical prongs are operatively connected to the light source for providing electrical power to the light source when the electrical prongs are received by an electrical receptacle of the electrical outlet with which the assembly is used in connection with.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The accompanying drawings, which are included to provide further understanding of the invention and are incorporated in and constitute a part of this specification, illustrate preferred embodiments of the invention and together with the description serve to explain the principles of the invention, in which:

FIG. 1 is a front perspective view of an illuminated door assembly in accordance with an embodiment of the invention showing a door panel in an open position permitting access to an underlying electrical receptacle registered with a through opening of the assembly;

FIG. 2 is a front perspective view of an illuminated door assembly in accordance with an embodiment of the invention showing a door panel in an closed position covering and limiting access to an underlying electrical receptacle;

FIG. 3 is a rear perspective view of the illuminated door assembly, showing electric prongs in a retracted position; and

FIG. 4 is an electric block diagram of an exemplary circuit comprising the electrical prongs and a light source.

### DETAILED DESCRIPTION OF THE INVENTION

As a preliminary matter, it should be noted that in this document (including the claims) directional terms, such as “above”, “below”, “upper”, “lower”, etc., are used for convenience in referring to the accompanying drawings. Additionally, it is to be understood that the various embodiments of the present invention described herein may be utilized in various orientations, such as inclined, inverted, horizontal, vertical, etc., without departing from the principles of the present invention.

The present disclosure is related to an illuminated door assembly for use in connection with an electrical outlet cover including a hinged door. The illuminated door assembly provides illumination to a low lit area and generally operates as a night light. An example of an electrical outlet cover for which the illuminated door assembly is suitable for use, is disclosed in U.S. Pat. No. 7,674,975, the entirety of which is included herein by reference. However, the disclosure should not be limited to only the electrical outlet cover disclosed by the '975 patent, as one of ordinary skill will appreciate many different electrical outlet covers include a hinged door may make use of the illuminated door assembly disclosed herein. Further, the invention disclosed herein can be utilized as a separate, standalone cover plate for an electrical outlet.

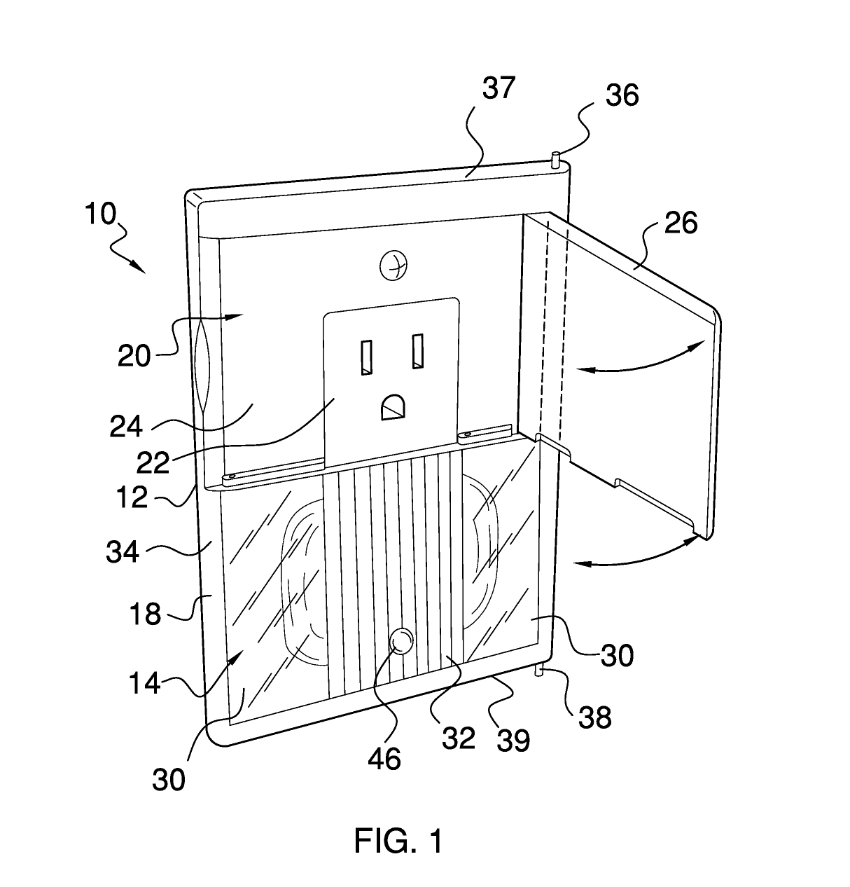

Representatively illustrated in FIGS. 1-3 is an illuminated door assembly 10 which embodies an embodiment of the invention. In an embodiment of the invention, the door assembly 10 is generally described and constructed for use in connection with the safety guard apparatus for an electrical outlet disclosed by U.S. Pat. No. 7,674,975 as a replacement door panel for the door panel therein which provides illumination to serve, for example, as a night light. However, it should be recognized, embodiments of the door assembly 10 disclosed herein are configured to be a standalone covering for an electrical outlet.

In an embodiment, the illuminated door assembly 10 includes a rectangular panel 12 that is of a generally rectangular configuration of a size sufficient to cover a conventional two receptacle electrical outlet. Panel 12 includes a front side 14, a rear side 16, a peripheral edge 18 and a through opening 20 extending from the front side 14 to the rear side 16 thereof. Through opening 20 configured to be registered with an electrical receptacle 22 of an electrical outlet 24 in which the door assembly 10 is used in connection with. Opening 22 is of a sufficient size to permit access to the underlying electrical receptacle 22 to plug an electrical cord into the electrical receptacle.

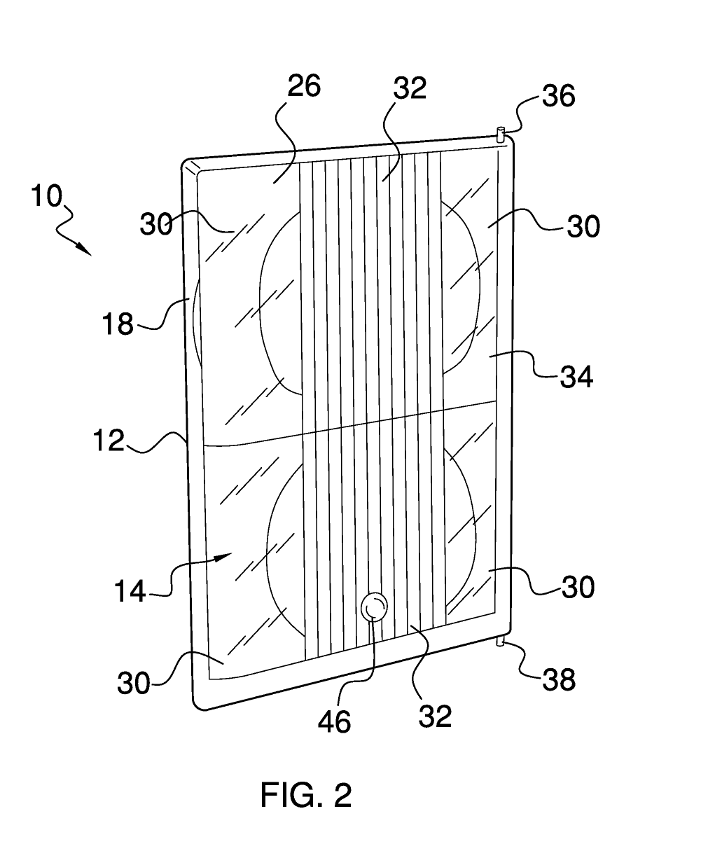

Door assembly 10 further includes a secondary door panel 26 that is hingedly attached to the panel 12 at the front side 14 thereof for rotation between an open position (as shown in FIG. 1) where the opening 22, and thus, the electrical outlet 24 is accessible and a closed position (as shown in FIG. 2) where the opening 22 is covered by the door panel 26, and thus covering and concealing the underlying electrical receptacle 24. In the closed position, door panel 26 is flush with the front side 14 of panel 12. As a safety measure, door panel 26 may be retained in the closed position by a friction lock which requires some force to overcome to prevent a child from opening the door panel and gaining access to the electrical outlet 24. A suitable friction lock may comprise a cooperating dent structure between panels 12 and 26.

The door assembly 10 further includes a light source 28, such as, for example an LED light assembly comprising one or more LEDs. The LEDs may be configured to emit a single color light or a multi-colored light as desired. With reference to FIGS. 1 and 2, the door assembly 10 is configured to transmit light emitted by the light source 28 through clear faces 30 of door panel 12 and of door panel 26 (when closed) to project the transmitted light outwardly from the door assembly 10. The door panel 12 and door panel 26 include decorative and corresponding vertical opaque faces 32 which do not transmit light from the light source 28. Further door panel 12 includes opaque faces 34 (surround trim) which does not transmit light from the light source 28.

In an embodiment the door assembly further includes hinge pins 36 and 38 extending from opposite ends 37 and 39 of the peripheral edge 18 of panel 12. Hinge pins 36 and 38 hingedly connect the panel 12 to a door frame of an electrical outlet cover for rotation between open and closed positions. Hinge pins 36 and 38 may be spring biased such that the pins are capable of retracting into the door panel 12 to permit coupling with a frame of an electrical outlet cover, such as, for example the frame of the electrical outlet cover disclosed in U.S. Pat. No. 7,674,975. It is important to note, alternative structures to hinge pins 36 and 38 could be used to hingedly connect door panel 12 to the frame of an electrical outlet cover. Additionally, hinge pins 36 and 38 may be eliminated altogether in an embodiment of the invention wherein the door assembly 10 is utilized as a separate, standalone cover plate for an electrical outlet.

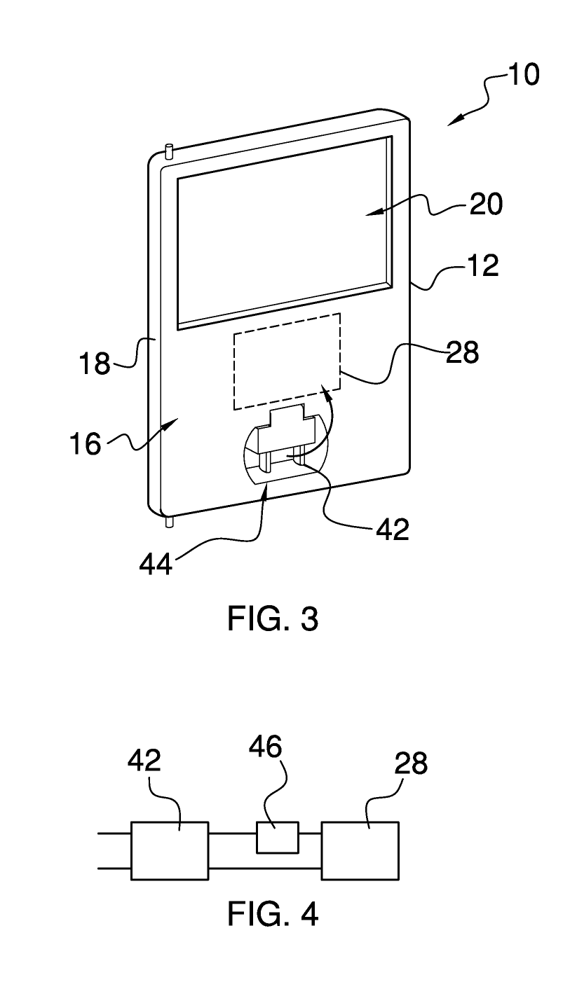

With particular reference to FIG. 3, a rear side 16 of the panel 12 is shown. As depicted here, the door assembly 10 further includes a male set of electrical prongs 42. Electrical prongs 42 are pivotally connected to the door panel 12 for rotation between a retracted position (as shown) and an extended position. In the retracted position, the prongs 42 are received by the door panel 12 in a manner such that the prongs do not project outward from the rear side 16 of the door panel. In the extend position, the prongs 42 are configured to be received by an underlying electrical receptacle (not shown) to provide electrical power to the light source 28. The rear side 16 may include a finger recess 44 to permit an operator to grip the prongs, for example, by a finger to extend the prongs 42 from the refracted position into the extending position for reception by an electrical receptacle.

FIG. 4 is a schematic block diagram of an embodiment of an electrical circuit including prongs 42, light source 28 and an optionally ambient light sensor 46. In the optional configuration including the light sensor 46, the light sensor operates to establish an electrical connection between prongs 42 and light source 28 when the ambient light is below a predetermined level and operates to preclude an electrical connection therebetween when the ambient light is above the predetermined level. Such light sensors are well known in the art, and the specific construction of the light sensor is not critical to its application. In an embodiment, the light sensor 46 is disposed with its light detecting portion extending through the front side of the panel 12.

A number of embodiments of the present invention have been described. Nevertheless, it will be understood that various modifications may be made without departing from the spirit and scope of the invention.

What is claimed is:

1. An illuminated door assembly for an electrical outlet, comprising:
a panel having a front side, a rear side and a through opening extending from said front side to said rear side thereof that is registered with an electrical receptacle of an electrical outlet with which said assembly is used in connection with, said opening of a sufficient size to permit access to said electrical receptacle permit the plugging of an electrical cord with said electrical receptacle;
a door panel hingedly attached to said panel for rotation between a closed position wherein said through opening is covered and an open position wherein said through opening uncovered and is accessible;
a light source carried by said panel;
said panel and said door each including clear faces through which light emitted by said light source is transmitted and projected outwardly from said panel; and
electrical prongs pivotally connected to said panel for rotation between retracted and extended positions, said male electrical prongs operatively connected to said light source for providing electrical power to said light source when said electrical prongs are received by an electrical receptacle of said electrical outlet with which said assembly is used in connection with.

2. The assembly of claim 1, wherein said door is hingedly attached at said front side of said panel.

3. The assembly of claim 1, wherein said electrical prongs are disposed on said rear side of said panel.

4. The assembly of claim 1, wherein said panel includes a finger recess on said rear side thereof permitting access to said electrical prongs when in said retracted position to permit the extending of said electrical prongs into said extended position.

5. The assembly of claim 1, further comprising:
a light sensor operably connected to said electrical prongs and said light source.

6. The assembly of claim 1, wherein said light source is comprised of one or more light emitting diodes.

7. The assembly of claim 1, further comprising:
a pair of hinge pins located on opposite ends of said panel.

8. The assembly of claim 7, wherein said door is hingedly attached at said front side of said panel.

9. The assembly of claim 7, wherein said electrical prongs are disposed on said rear side of said panel.

10. The assembly of claim 7, wherein said panel includes a finger recess on said rear side thereof permitting access to said electrical prongs when in said retracted position to permit the extending of said electrical prongs into said extended position.

11. The assembly of claim 7, further comprising:
a light sensor operably connected to said electrical prongs and said light source.

12. The assembly of claim 7, wherein said light source is comprised of one or more light emitting diodes.
